(19) United States
(12) Patent Application Publication
(10) Pub. No.: US 2013/0272295 A1
(43) Pub. Date: Oct. 17, 2013

(54) Legacy to Cloud Telephone System

(71) Applicant: Paul Steven von Wachter Mahler, Woodside, CA (US)

(72) Inventor: Paul Steven von Wachter Mahler, Woodside, CA (US)

(21) Appl. No.: 13/444,280

(22) Filed: Apr. 11, 2012

(51) Int. Cl. H04L 12/66

(52) U.S. Cl. 370/352

(57) ABSTRACT

A virtual private branch exchange (VPBX) has an internet-connected server with at least one digital processor coupled to a data repository, and software executing on the one or more processors from a non-transitory medium. The VPBX maintains configuration data for individual legacy PBX systems, including telephony services enabled by the software to be provided to each legacy PBX system, receives packet-data protocol telephone calls uniquely digitally associated with the individual legacy systems, forwards those calls via a gateway to PSTN destinations, or via the Internet to IP destinations, and provides additional telephony services associated at the VPBX with each legacy system.

### BACKGROUND OF THE INVENTION

1. Field of the Invention

The present invention is in the technical field of telephone systems, including conventional dedicated wiring systems and packet network systems.

2. Description of Related Art

Telephone systems are typically separated into two segments, one called in the art the network, and the other local premises equipment. In current art the well-known Public Switched Telephone Network (PSTN) operates with dedicated trunk lines and network switches connected to local premises equipment in both homes, including apartment systems, and enterprises like commercial businesses and other organizations with multiple personnel, where several to many telephones may be served internally through a Private Branch Exchange (PBX), which is based typically on a somewhat computerized telephone switch.

There are arguably no two PBX systems that are exactly alike, and many commercial systems are available and have been sold and installed in millions of instances. The features that are available through individual ones of the installed base of PBX systems vary enormously, and in most cases the local premises equipment is a maze of boxes and wiring that may be built into walls, floors, overheads and the like in the premises of the enterprise.

To upgrade telephone service for an enterprise tied to such a system often requires severe rebuilding and retrofitting, and in many instances, complete replacement of all the components internally.

What is clearly needed is a system that can provide a broad range of additional features and services without having to disturb or replace the existing legacy PBX system, and that can be easily upgraded as new services become available.

### BRIEF SUMMARY OF THE INVENTION

In an embodiment of the invention a virtual private branch exchange (VPBX) is provided, comprising an internet-connected server with at least one digital processor coupled to a data repository, and software executing on the one or more processors from a non-transitory medium. A VPBX supplements the services available for the legacy PBX. The VPBX maintains configuration data for individual legacy PBX systems, including telephony services enabled by the software to be provided to each legacy PBX system, receives packet-data protocol telephone calls uniquely digitally associated with the individual legacy systems, forwards those calls via a gateway to PSTN destinations, or via the Internet to IP destinations, and provides additional telephony services associated at the VPBX with each legacy system.

In one embodiment of the VPBX certain services or functions are triggered by a digital sequence associated with the certain service or function and with a specific legacy PBX, but not associated as a call destination. Also in one embodiment the gateway receives PSTN calls destined for individual legacy systems, converts those calls to the packet-data protocol, and forwards those calls via the VPBX to the associated individual legacy PBX system, where a local gateway converts the incoming calls to PSTN protocol for the individual legacy PBX. The local gateway also converts outgoing calls from the associated legacy PBX to the packet-data protocol, and identifies those calls as originating from the associated legacy PBX system.

In another aspect of the invention a method for enhancing services for a specific legacy PBX system is provided, comprising the steps of (a) providing a virtual PBX (VPBX) on an internet-connected server with at least one digital processor coupled to a data repository, and software executing on the one or more processors from a non-transitory medium, the VPBX maintaining configuration data for the specific legacy PBX system, and other similar systems, the VPBX providing telephony services enabled by the software; (b) receiving packet-data protocol telephone calls uniquely digitally associated with the specific legacy system, and forwarding those calls via a gateway to PSTN destinations, or via the Internet to IP destinations; and (c), providing additional telephony services associated at the VPBX with each legacy system.

In one embodiment of the method certain services or functions at the VPBX are triggered by a digital sequence associated with the certain service or function and also the specific legacy PBX system, but not associated as a call destination. Also in one embodiment the gateway receives PSTN calls destined for individual legacy systems, converts those calls to the packet-data protocol, and forwards those calls via the VPBX to the associated individual legacy PBX system, where a local gateway converts the incoming calls to PSTN protocol for the individual legacy PBX. Also in one embodiment the local gateway converts outgoing calls from the associated legacy PBX to the packet-data protocol, and identifies those calls as originating from the associated legacy PBX system.

In one embodiment of the method all or most services or functions at legacy PBX are replaced by the VPBX, for example in the case where the legacy premises equipment, premises gateway or the packet network connectivity are not operational (“down”).

### BRIEF DESCRIPTION OF THE SEVERAL VIEWS OF THE DRAWINGS

FIG. 1 is an architecture diagram of a PSTN and one representative PBX legacy system.

FIG. 2 is an architecture diagram representing the system of FIG. 1 and an additional enhancement system according to an embodiment of the present invention.

### DETAILED DESCRIPTION OF THE INVENTION

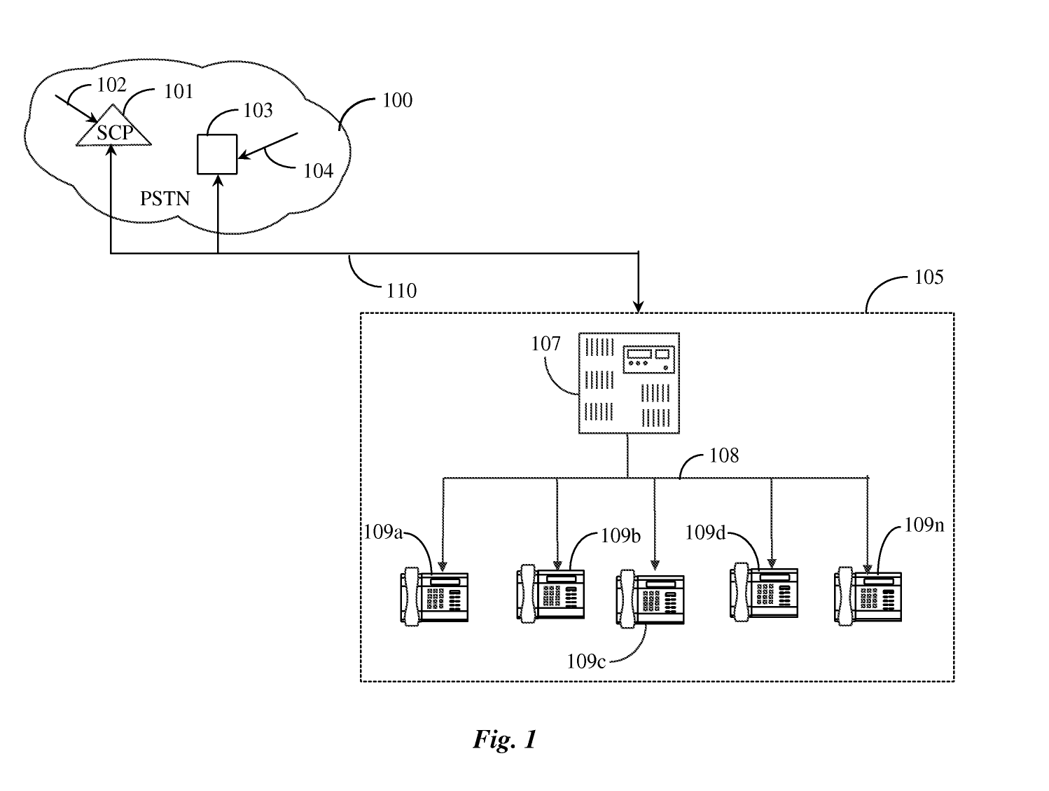

FIG. 1 is an architecture diagram of a PSTN 100 and one representative PBX legacy system operating in a representative enterprise 105, as known in the current art. In this example, PSTN 100 includes a representative Service Control Point 101 at which calls 102 to toll-free numbers are intercepted and redirected to various enterprises by trunk lines 110 to a PBX switch 107 in enterprise 105. Other switches 103, local and otherwise in PSTN 100, switch direct number calls 104 to PBX 107 where calls are directed to internal telephones 109a through 109n by internal lines 108. The telephones in the enterprise typically have destination numbers (DNs), and persons at these telephones may make internal calls to one another without incurring toll charges. In this prior art example all of the features of the internal telephone system are provided by hardware and software comprising the PBX 107, which in some cases may or may not be computer enhanced. For the purpose of this description computer enhancement is not shown separately, but is to be considered as part of the basis of the set of features and services of the PBX system. As described above in the background section, an enterprise, to add features and services may typically have to rip out and replace the entire PBX system.

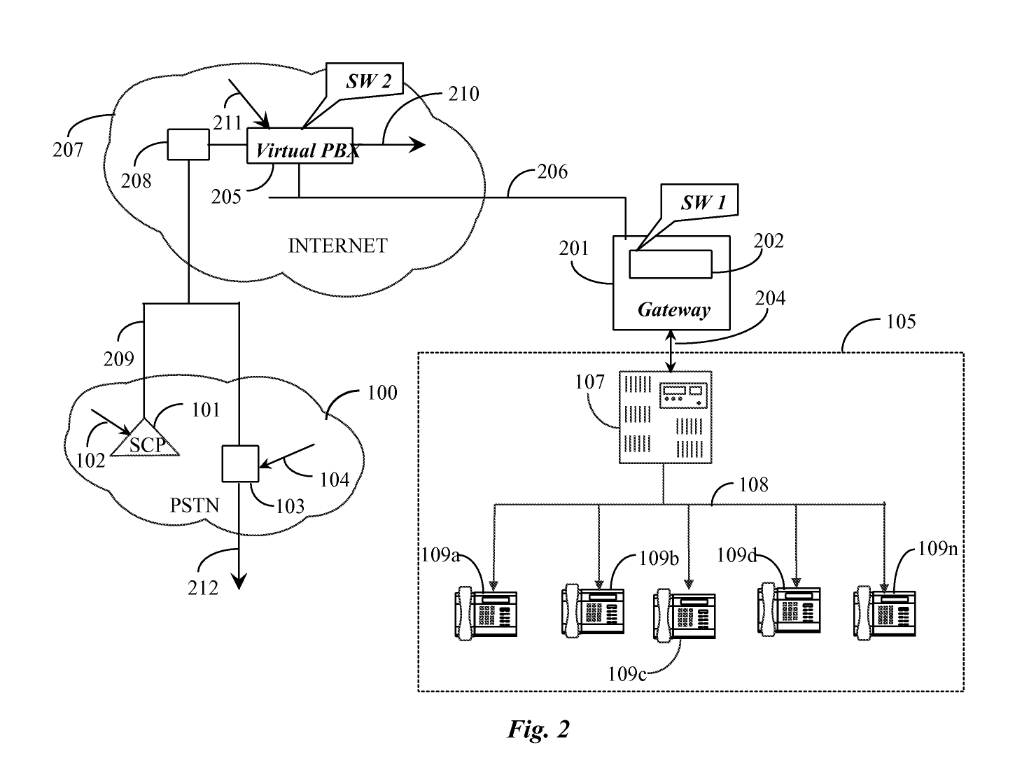

FIG. 2 is an architecture diagram representing the system of FIG. 1 with additional elements according to an embodiment of the present invention. In FIG. 1 legacy system 105 is limited to PSTN functionality and the features of PBX switch 107. In the embodiment of the invention represented in FIG. 2 PSTN lines 204 connected to switch 107 terminate at a gateway 201 where outgoing calls are converted to packet network telephone calls, such a Session Initiation Protocol (SIP) calls, which are translated and forwarded via Internet connection by path 206 into Internet network 207. The packet network protocol may be SIP or any other protocol by which packet telephony may be accomplished. Gateways such as Gateway 201 are known in the art for translating and forwarding calls as packet network calls.

Gateway 201 has at least one digital processor 202 executing software, SW1. The gateway is programmable to associate outgoing calls to packets with particular IP addresses. In typical commercial instances PSTN calls are translated to SIP (or other packet protocol) and addressed to remote gateways where the SIP calls are either terminated at SIP-capable devices, or translated back to PSTN protocol to be delivered in a PSTN network. This arrangement saves PSTN charges between source and destination for the enterprise with the legacy system.

The legacy PBX may provide a direct network connection that provides outgoing calls as packets to one or more IP addresses. That is, the gateway may be directly incorporated within the legacy PBX.

In various embodiments of the present invention a virtual PBX (VPBX) 205 is provided, typically as an Internet-connected server executing a rich software suite SW2, and outgoing calls from legacy system 105 are addressed in the translation by Gateway 201 to VPBX 205. In a similar fashion, PSTN calls represented by arrows 102 and 104, destined for legacy PBX 107 from PSTN 100, which may be via a Service Control Point (SCP) 101 or another PSTN switch 103, go to a supplemental gateway 208 associated with VPBX 205, and are translated to SIP or other packet protocol and managed by the VPBX. Other incoming may be packet protocol telephone calls 211. All these incoming calls are forwarded to gateway 201 via Internet connection 206, and are translated back to PSTN protocol and delivered to legacy PBX 107.

The skilled person will understand that gateways such as 201 may be programmed to address packet calls to VPBX 205, where a broad variety of enhanced services may be provided for legacy system 105. Further, in an embodiment of the invention services at VPBX 205 are configured for individual enterprises operating legacy PBX systems. There may be a large number of enterprises as customers of the enterprise hosting VPBX 205, and the suite of services and functionality of the virtual PBX may be customized for each customer. Such customization may occur as standard service suites which a customer may select to use, or may be configured on a more detailed level. This configuration occurs by programming and data provision in conjunction with SW2.

As an example of services that may be provided to a customer, an individual customer may have a legacy PBX that has a single-level Interactive Voice Response (IVR) system, and may wish to have an IVR with additional levels of response and particularity. To accomplish this without the present invention would require serious alteration to the existing PBX, if it could be done at all, or even complete replacement of the PBX. In practice of the present invention, by use of gateway 201 to VPBX 205, the customer may have any one of a variety of available multi-level IVRs, or one designed entirely for that customer, and changes in the operation of the new IVR may be done regularly and simply.

As another example, many legacy PBX systems do not support conferencing. Moreover, conferencing in a PSTN system is a more complicated process than conferencing in a SIP system, for example. Every customer may have an individually configured conferencing bridge, without alteration to the existing legacy system.

Another feature in embodiments of the present invention is that a customer may specify alternative communication devices associated with personnel at the enterprise, and associate those devices with the hard-wired telephones 109, VoIP devices, cellular or other similar telephones, or just with company personnel and managers. VPBX 205, configured for that customer, is capable of delivering incoming calls to the alternative devices as well as the hard-wired telephones, and rule sets may be imposed to control when and how the call direction may be accomplished.

The alternative device inclusion by the VPBX, configured for an individual customer provides a failover system not available in any way with the legacy PBX. If PBX 107 fails, company personnel may use the alternative devices for outgoing, and still enjoy the services provided by the VPBX. Incoming can be directed to the alternative devices as well. So failure of the legacy system does not shut the business down.

Similarly, a customer with more than one premises, having different legacy systems in each premises, which may often occur as a company grows and acquired other enterprises, may enhance and standardize their services through the VPBX. The VPBX can connect the different legacy systems to provide additional functions not available to the legacy telephone equipment.

Additional features that may be added with the VPBX include modern features such as conference bridges, call queues, distribution lists, voicemail or extended voicemail features, and Interactive Voice Response systems (IVRs), part of which were described above.

In one embodiment features may be provided by reserving numbers, for example 999-9999, which might activate or provide access to features such as find-me follow-me, voice mail, three-way dialing and the like. These reserved numbers may be telephone numbers not used for other purposes, or may be dialpad key sequences entered on telephones 109, which are translated at gateway 201 to address special features in VPBX 205.

Another feature possible and provided in embodiments of the present invention is maintenance of call detail records which may be collected and reported by the VPBX for individual customers. Many legacy systems do not have good call cost management systems. Companies with multiple offices or locations can now, with the use of a gateway according to an embodiment of the present invention, all talk to each other over the internet, completely bypassing toll charges (via the PSTN) for office-to-office calls, without changing the existing telephone hardware.

In embodiments of the invention the enhanced gateway may be provided by a telephone company or by a third-party provider for the enterprise as customer. The enhanced system is programmable for services selectable by the customer, although there may be standard service packages for the convenience of, for example, pricing. In many embodiments the enhanced system also may be programmed with considerable data and profile information particular to the customer enterprise. The customer may provide, for example, contact lists which may be used by the enhancing gateway for a variety of purposes.

The skilled person will recognize that a VPBX such as VPBX 205 may be provided in any location that has Internet connectivity. Such VPBX systems according to embodiments of the present invention may be duplicated and scattered in many geographic patterns for various purposes.

In one embodiment the VPBX may be provided as a part of SW 1 executing on processors 202 at gateway 201, or may be provided as a “black box” connected to gateway one by a high-speed digital connection, also coupled to a mass storage device, and programmable either locally or remotely. In the local case, a third-party provider may upgrade and enhance services for a customer by remote programming and data transfer.

The skilled person will understand that the invention has been described in many embodiments above, but that the embodiments described are examples, and that the invention may be provided and practiced in many other ways equivalent to the examples described herein. These changes are to be recognized as within the spirit and scope of the present invention.

The VPBX runs on an internet-connected server with at least one digital processor coupled to a data repository, and software executing on the one or more processors from a non-transitory medium, As the VPBX is virtual, it can be installed at any location, for example a remote location, at the customer premises, or even within the gateway installed at the customer premises.

1. A virtual private branch exchange (VPBX), comprising:
an internet-connected server with at least one digital processor coupled to a data repository; and
software executing on the one or more processors from a non-transitory medium;
wherein the VPBX maintains configuration data for individual legacy PBX systems, including telephony services enabled by the software to be provided to each legacy PBX system, receives packet-data protocol telephone calls uniquely digitally associated with the individual legacy systems, forwards those calls via a gateway to PSTN destinations, or via the Internet to IP destinations, and provides additional telephony services associated at the VPBX with each legacy system.

2. The VPBX of claim 1 wherein certain services or functions are triggered by a digital sequence associated with the certain service or function, but not associated as a call destination.

3. The VPBX of claim 1 wherein the gateway receives PSTN calls destined for individual legacy systems, converts those calls to the packet-data protocol, and forwards those calls via the VPBX to the associated individual legacy PBX system, where a local gateway converts the incoming calls to PSTN protocol for the individual legacy PBX.

4. The VPBX of claim 3 wherein the local gateway converts outgoing calls from the associated legacy PBX to the packet-data protocol, and identifies those calls as originating from the associated legacy PBX system.

5. A method for enhancing services for a specific legacy PBX system, comprising the steps:
(a) providing a virtual PBX (VPBX) on an internet-connected server with at least one digital processor coupled to a data repository, and software executing on the one or more processors from a non-transitory medium, the VPBX maintaining configuration data for the specific legacy PBX system, and other similar systems, the VPBX providing telephony services enabled by the software;
(b) receiving packet-data protocol telephone calls uniquely digitally associated with the specific legacy system, and forwarding those calls via a gateway to PSTN destinations, or via the Internet to IP destinations; and
(c), providing additional telephony services associated at the VPBX with each legacy system.

6. The method of claim 5 wherein certain services or functions at the VPBX are triggered by a digital sequence associated with the certain service or function and also the specific legacy PBX system, but not associated as a call destination.

7. The method of claim 5 wherein the gateway receives PSTN calls destined for individual legacy systems, converts those calls to the packet-data protocol, and forwards those calls via the VPBX to the associated individual legacy PBX system, where a local gateway converts the incoming calls to PSTN protocol for the individual legacy PBX.

8. The method of claim 7 wherein the local gateway converts outgoing calls from the associated legacy PBX to the packet-data protocol, and identifies those calls as originating from the associated legacy PBX system.
